(19) United States
(12) Patent Application Publication
(10) Pub. No.: US 2026/0089599 A1
(43) Pub. Date: Mar. 26, 2026

(54) METHOD TO IMPROVE USER VOICE CALL EXPERIENCE USING SLEEP MODE MEASUREMENTS AND MOTION ESTIMATION

(71) Applicant: Apple Inc., Cupertino, CA (US)

(72) Inventors: Sushant VIKRAM, San Diego, CA (US); Ankit M MEHROTRA, San Diego, CA (US); Bhargav PINNI, San Jose, CA (US); Ajay SINGH, San Jose, CA (US); Pradeep S SHARMA, Cupertino, CA (US)

(73) Assignee: Apple Inc., Cupertino, CA (US)

(21) Appl. No.: 18/891,048

(22) Filed: Sep. 20, 2024

(51) Int. Cl. H04W 36/30; H04W 52/02

(52) U.S. Cl. CPC H04W 36/304; H04W 52/0254

(57) ABSTRACT

Aspects are described for a user equipment (UE) having a transceiver and a processor communicatively coupled to the transceiver. The processor configures the UE to enter a low-power mode and determines that the UE is in a motion state. The processor determines that the UE has performed a voice communication for a first predetermined period. The processor measures signal qualities of neighboring cells while the UE is in the low-power mode in response to determining that the UE is in the motion state and that the UE has performed the voice communication for the first predetermined period.

### BACKGROUND

### Field

The described aspects generally relate to sleep mode measurements based on motion estimation.

### SUMMARY

Some aspects of this disclosure relate to systems, apparatuses, and methods for implementing sleep mode measurements based on motion estimation. For example, the systems, the apparatuses, and the methods are provided for measuring neighbor cells while in a sleep mode to improve user voice call experience.

Some aspects of this disclosure relate to a user equipment (UE) having a transceiver and a processor communicatively coupled to the transceiver. The processor configures the UE to enter a low-power mode and determines that the UE is in a motion state. The processor further determines that the UE has performed a voice communication for a first predetermined period. The processor measures signal qualities of neighboring cells while the UE is in the low-power mode in response to determining that the UE is in the motion state and that the UE has performed the voice communication for the first predetermined period.

Some aspects of this disclosure relate to a method of operating a UE. The method includes configuring the UE to enter a low-power mode and determining that the UE is in a motion state. The method further includes determining that the UE has performed a voice communication for a first predetermined period. The method further includes measuring signal qualities of neighboring cells while the UE is in the low-power mode in response to determining that the UE is in the motion state and that the UE has performed the voice communication for the first predetermined period.

Some aspects of this disclosure relate to a non-transitory computer-readable medium (CRM) having instructions, wherein upon execution of the instructions by one or more processors of a user equipment (UE), causes the UE to perform operations. The operations include configuring the UE to enter a low-power mode and determining that the UE is in a motion state. The operations further include determining that the UE has performed a voice communication for a first predetermined period. The operations further include measuring signal qualities of neighboring cells while the UE is in the low-power mode in response to determining that the UE is in the motion state and that the UE has performed the voice communication for the first predetermined period.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing sleep mode measurements based on motion estimation, according to some aspects of the disclosure.

FIG. 2 illustrates a block diagram of an example system of an electronic device for the sleep mode measurements, according to some aspects of the disclosure.

FIG. 3A illustrates an example wakeup-sleep cycle with an early scheduling request (SR), according to aspects of the disclosure.

FIG. 3B illustrates an example wakeup-sleep cycle with an adjusted SR, according to aspects of the disclosure.

FIG. 4 illustrates an example method of sleep mode measurements, according to aspects of the disclosure.

FIG. 5 illustrates an example method of the sleep mode measurements in a motion state and during a voice communication, according to aspects of the disclosure.

FIG. 6 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for implementing sleep mode measurements based on motion estimation. For example, the systems, the apparatuses, and the methods are provided for measuring neighbor cells while in a sleep mode to improve user voice call experience.

In some aspects, a user equipment (UE) in a wireless communication network, such as a 5G network, can enter a sleep mode periodically. The sleep mode is also known as a power-saving mode or a low-power mode, where the UE temporarily reduces power consumption to conserve battery life while still maintaining a connection to the wireless communication network. For example, the UE can limit or refrain from transmitting and/or receiving signals using a transceiver of the UE in the sleep mode. Since the transceiver utilizes significant power during transmission, sleep mode can save energy and extend the battery life of the UE.

In some aspects, the UE needs to request transmission resources before the UE can transmit data. For example, after the UE exits the sleep mode (and enters a wakeup mode), the UE needs to transmit a scheduling request (SR) to a base station serving the UE to request data transmission resources. The UE can subsequently receive a resource grant from the base station and start to transmit data using the granted resources.

In some aspects, the UE can toggle between the sleep mode and the wakeup mode. For example, the UE can go to the sleep mode when there is no data to transmit and switch back to the wakeup mode when data become available to transmit. In some aspects, the UE can engage in voice communication using speech/silence frames. For example, when a user of the UE speaks, the UE generates speech frames to transmit. In such a case, the UE switches to the wakeup mode. On the other hand, when the user is silent, the UE may generate silence frames or no frame at all. In such a case, the UE switches to the sleep mode because there is nothing to transmit.

In some aspects, the UE may switch to the wakeup mode as soon as the UE determines that there is data to be transmitted. For example, the UE may switch to the wakeup mode to transmit the SR when the UE detects voice activities. However, the UE may need to stay in the wakeup mode while the UE processes the voice activities and until the UE can transmit data corresponding to the voice activities using the granted resource. In such a case, the UE stays in the wakeup mode during this period between transmitting the SR and transmitting the data with nothing else to transmit. Thus, the transceiver of the UE consumes energy just to stay on. In other aspects, the UE switches to the wakeup mode when the data is ready to transmit or at least will be ready to transmit in a predetermined period. In this way, the UE consumes less energy because the UE switches to the wakeup mode later.

In some aspects, the UE can measure neighboring cells while in the wakeup mode. For example, the UE can receive signals from neighboring cells not currently serving the UE and measure signal qualities of the neighboring cells, such as signal power, signal-to-noise ratio (SNR), signal-to-interference-plus-noise ratio (SINR), or other matrices. In such a case, when the UE needs to handover to another cell, the UE can initiate a handover process based on the signal qualities of the neighboring cells. For example, the UE can determine that a first cell has the strongest signal power amongst all measured neighboring cells and then handover to the first cell. Thus, the UE can complete the handover process quickly to minimize the impact on ongoing communications of the UE. For another example, the UE can prioritize the first cell when searching for a new cell for handover. Because the first cell has the strongest signal power amongst all measured neighboring cells, it is possible that the UE will eventually handover to the first cell.

In some aspects, because the UE switches to the wakeup mode when the data is ready, or close to ready, for transmission as discussed above, the UE may not be able to actively measure the neighboring cells before switching to the wakeup mode. Thus, the handover procedure may cause delays to the UE communication. For example, when the UE is conducting a voice communication, such as the voice communication using speech and silence frames as discussed above, the UE may not be able to perform the handover quickly enough to transmit the speech frames without delay due to the lack of measurements of the neighboring cells.

In some aspects, the UE can trigger the active measurements even in the sleep mode, i.e., the UE can perform sleep mode measurements. For example, the UE can measure signal qualities of the neighboring cells while the UE is in the sleep mode. The UE can temporarily turn on the transceiver to receive signals from the neighboring cell and then turn the transceiver back off. In some aspects, because the sleep mode measurements consume additional energy, the UE can choose to perform the sleep mode measurement when necessary. For example, UE can perform the sleep mode measurement during a voice communication. For another example, the UE can perform the sleep mode measurements when no handover has been performed recently. For yet another example, the UE can perform the sleep mode measurement while moving.

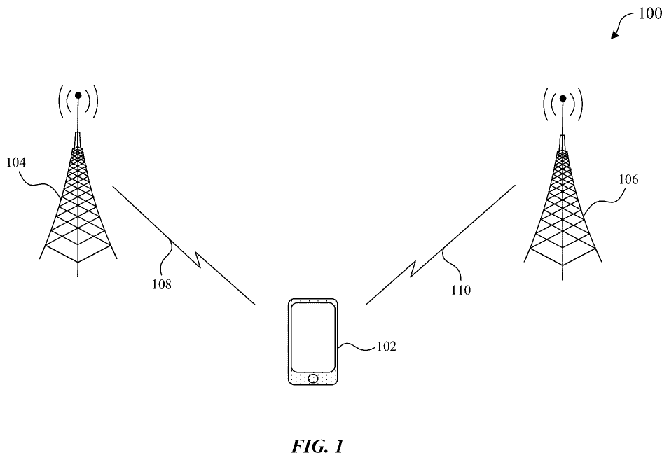

FIG. 1 illustrates an example system 100 implementing sleep mode measurements based on motion estimation, according to some aspects of the disclosure. The example system 100 is provided for the purpose of illustration only and does not limit the disclosed aspects. The example system 100 may include, but is not limited to, a UE 102, a base station 104, and a base station 106. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 may be configured to operate using one or more 3GPP releases, such as Release 15 (Rel-15), Release 16 (Rel-16), Release 17 (Rel-17), Release 18 (Rel-18), or other 3GPP releases. The UE 102 may include, but is not limited to, wireless communication devices, smartphones, laptops, desktops, tablets, personal assistants, monitors, televisions, wearable devices, Internet of Things (IoT) devices, vehicle communication devices, and the like. The base stations 104 and 106 may include one or more nodes configured to operate based on a wide variety of wireless communication techniques such as, but not limited to, techniques based on the 3GPP standards. For example, the base stations 104 and 106 may include nodes configured to operate using Rel-15, Rel-16, Rel-17, Rel-18, or other 3GPP releases. The base stations 104 and 106 may include, but not limited to, NodeBs, evolved NodeBs (eNodeBs), next generation NodeBs (gNBs), new radio base stations (NR BSs), access points (APs), remote radio heads, relay stations, transmission/ reception points (TRPs), and others.

In some aspects, the UE 102 connects with the base station 104 via a communication link 108. The communication link 108 can include uplink (UL) connections and downlink (DL) connections. For example, the UE 102 can transmit data to the base station 104 via the communication link 108. In some aspects, the UE 102 can be in a sleep mode or a wakeup mode. In the wakeup mode, the UE 102 can actively communicate with the base station 104, e.g., the UE 102 can transmit data to and receive data from the base station 104 via the communication link 108 in the wake up mode. In the sleep mode, the UE 102 can turn off or limit a transceiver of the UE 102. In some aspects, the UE 102 can turn on the transceiver when there is data to be transmitted. In addition, the UE 102 can also turn on the transceiver periodically to check whether the base station 104 has transmitted a wakeup signal. Otherwise, the transceiver of the UE 102 is turned off during the sleep mode to reduce power consumption.

In some aspects, the base station 106 can be a neighboring base station supporting one or more neighboring cells. When the UE 102 moves toward to the base station 106 and away from the base station 104, the UE 102 can handover to a new cell supported by the base station 106. The new cell can be a cell of the one or more cells. In some aspects, the UE 102 can measure the one or more cells during the handover and determine to handover to the new cell. For example, the UE 102 can determine that the new cell has the best signal quality among the one or more cells. However, such a handover procedure may require extensive time to measure the one or more cells. In other aspects, the UE 102 can measure the one or more cells prior to the handover procedure. For example, the UE 102 can continuously measure the one or more cells. In such a case, when the UE 102 initiates the handover procedure, the UE 102 can either handover to the new cell directly or prioritize the new cell during a cell search to expedite the handover procedure.

In some aspects, the UE 102 can enter the sleep mode periodically. The UE 102 may not be able to measure the one or more cells when in the sleep mode because the transceiver is turned off or limited. In such a case, when the UE 102 needs to perform a handover as soon as the UE 102 wakes up, the UE 102 may not have measurement results of the one or more cells as discussed above. Thus, the performance of the UE 102 can be impacted because of delays caused by the measurements. For example, the UE 102 conducts a voice communication and needs to transmit speech data after waking up. However, because the UE 102 is moving away from the base station 104 and toward the base station 106, the UE 102 needs to handover to the base station 106 before transmitting the speech data. Without the measurement results of the one or more cells, the handover procedure can delay the transmission of the speech data and thus impact the performance of the UE 102 in the voice communication.

In some aspects, the UE 102 can measure the one or more cells even in the sleep mode. For example, the UE 102 can determine that the UE 102 is moving while in the sleep mode. In some aspects, the UE 102 may include a motion sensor (not shown) that can determine whether the UE 102 is in a motion state or a stationary state. The UE 102 can further determine that the UE 102 is conducting a delay-sensitive communication, such as a voice communication. In such a case, the UE 102 can trigger sleep mode measurements so that the UE 102 can later perform the handover based on the measurement results.

In some aspects, the UE 102 can perform the sleep mode measurements regarding other cells supported by other base stations (not shown) in a similar way. For example, the UE 102 can measure signals from all neighboring cells including the one or more cells and other cells. The UE 102 can then rank the neighboring cells based on signal qualities, such as signal strengths, SNR, SINR, and so on. When the UE 102 wakes up and starts the handover procedure, the UE 102 can prioritize the cells ranked high among the neighboring cells.

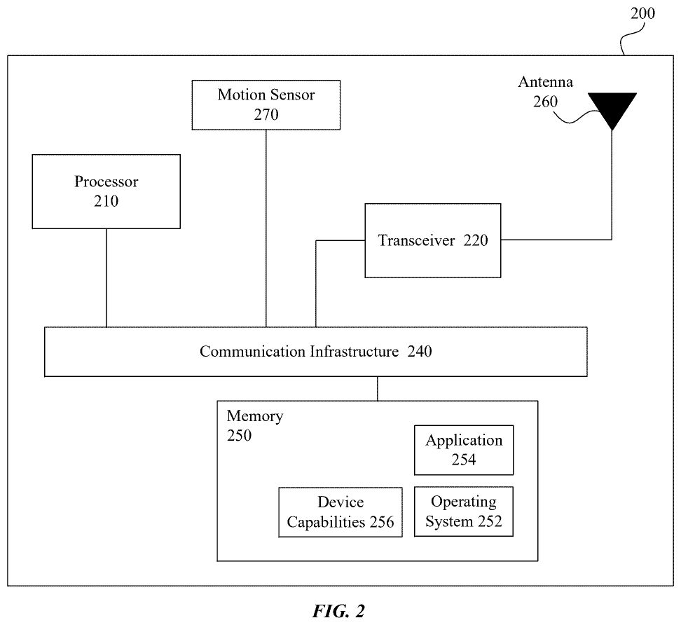

FIG. 2 illustrates a block diagram of an example system of an electronic device for the sleep mode measurements, according to some embodiments of the disclosure. The electronic device 200 may be any of the electronic devices (e.g., the UE 102, the base station 104, the base station 106) of the system 100. The electronic device 200 includes a processor 210, one or more transceivers 220, a communication infrastructure 240, a memory 250, an operating system 252, an application 254, device capabilities 256, antenna 260, and a motion sensor 270. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. In some embodiments, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement the sleep mode measurements, as described herein. Alternatively, or additionally, the processor 210 can be “hard coded” to implement mechanisms for the sleep mode measurements, as described herein.

The one or more transceivers 220 transmit and receive communications signals support mechanisms for the sleep mode measurements. Additionally, the one or more transceivers 220 transmit and receive communications signals that support mechanisms for measuring communication link(s), generating and transmitting system information and data, and receiving the system information and data. According to some embodiments, the one or more transceivers 220 may be coupled to the antenna 260 to wirelessly transmit and receive the communication signals. The antenna 260 may include one or more antennas that may be the same or different types and can form one or more antenna ports. In some embodiments, the antenna 260 can be replaced or used in combination with wired communication interferences, such as Ethernet, Universal Serial Bus (USB), serial port, serial advanced technology attachment (SATA), and fiber optic interferences. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

In some aspects, the one or more transceivers 220 may include a main transceiver and a secondary transceiver. When the electronic device 200 enters a sleep mode, as discussed above, the electronic device 200 can turn off the main transceiver to reduce power consumption. However, the secondary transceiver is kept on to receive signals from a serving base station. The signals can include wakeup signals and other data signals. In some aspects, when the secondary transceiver receives and detects a wakeup signal, the secondary transceiver can trigger the main transceiver to wake up in order to receive additional data from the serving base station.

According to some embodiments of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

In some aspects, the motion sensor 270 can determine whether the electronic device 200 is in a motion state or a stationary state. For example, the motion sensor 270 can determine a velocity of the electronic device 200 including a speed and a direction. In some aspects, the motion sensor 270 can determine that the speed is lower than a threshold and thus the electronic device 200 is in the stationary state. On the other hand, the motion sensor 270 can also determine that the speed is higher than the threshold and thus the electronic device 200 is in the motion state. In some aspects, the motion sensor can report the velocity to the processor 210 via the communication infrastructure 240. In such a case, the processor 210 can determine whether the electronic device 200 is the motion state or the stationary state based on the velocity.

In some aspects, the motion sensor 270 is always on, even in the sleep mode. In such a case, the electronic device 200 can keep track of its motion status. In other aspects, the motion sensor 270 can be turned on and off based on triggering events. For example, the transceiver 220 can receive, via the antenna 260, signals from a serving base station, such as the base station 104. The transceiver 220 can measure a signal strength of the signals and report it to the processor 210. The processor 210 can determine that the signal strength is below a predetermined power level and trigger the motion sensor 270 to monitor the motion status of the electronic device 200. Similarly, the motion sensor 270 can also be triggered when the electronic device 200 initiates a delay-sensitive communication, such as a voice communication, and other events.

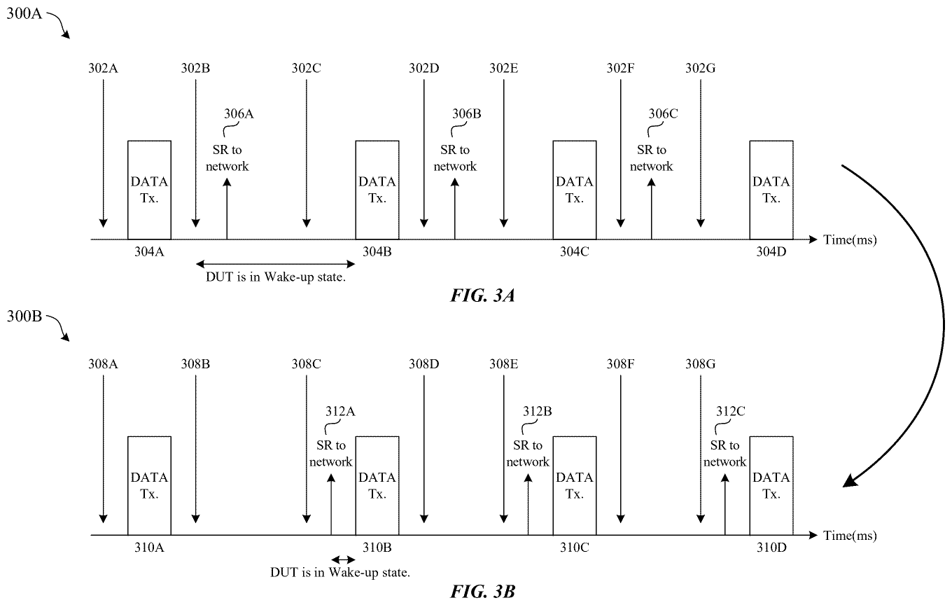

As discussed in more detail below with respect to FIGS. 3A, 3B, and 4-6, processor 210 may implement different mechanisms for the sleep mode measurements as discussed with respect to the system 100 of FIG. 1.

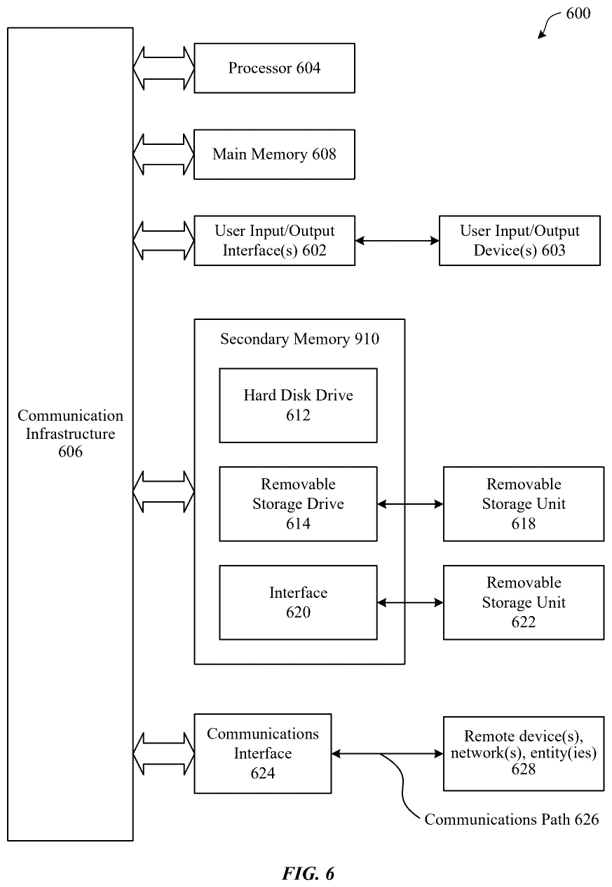

FIG. 3A illustrates an example 300A of a wakeup-sleep cycle with an early scheduling request (SR), according to aspects of the disclosure. The example 300A is provided for the purpose of illustration only and does not limit the disclosed aspects. As a convenience and not a limitation, FIG. 3A may be described with regard to elements of FIGS. 1, 2, and 6. The example 300A may represent the operation of electronic devices (for example, the UE 102 and the base stations 104 and 106 of FIG. 1) implementing the sleep mode measurements. The example 300A may also be performed by the electronic device 200 of FIG. 2, controlled or implemented by processor 210, and/or computer system 600 of FIG. 6. But the example 300A is not limited to the specific aspects depicted in those figures and other systems may be used to perform the method, as will be understood by those skilled in the art. It is to be appreciated that not all operations may be needed, and the operations may not be performed in the same order as shown in FIG. 3A.

In some aspects, the example 300A includes time points 302A, 302B, 302C, 302D, 302E, 302F, and 302G. A base station, such as the base station 104, serving a UE, such as the UE 102, can transmit downlink data at these time points. The UE can wake up to receive the downlink data or stay in the sleep mode in these time points. For example, if the downlink data include wakeup signals, the UE can wake up to receive signals. However, if the downlink data does not include wakeup signals, the UE can stay in the sleep mode.

In some aspects, the UE can be configured with uplink data transmission time periods, such as transmission periods 304A, 304B, 304C, and 304D. The UE wakes up and transmits uplink data in these transmission periods. The uplink data include speech frames as discussed above and other data to be sent to the base station. Thus, regardless of whether the UE wakes up in the time points 302A, 302B, 302C, 302D, 302E, 302F, and 302G to receive downlink signals, the UE can wake up in the transmission periods 304A, 304B, 304C, and 304D to transmit uplink signals. For example, the UE can transmit an SR in a time point 306A to the base station. The base station can allocate resources, such as the transmission period 304B, to the UE. In some aspects, the UE may determine that there is data to be transmitted at the time point 306A. For example, the UE may detect voice activities and generate speech frames at the time point 306A. For another example, the UE may determine that the data is pending in the medium access control (MAC) layer at the time point 306A. In either case, the UE needs to wait until a next granted transmission period, e.g., the transmission period 304B, to transmit uplink data. In some aspects, the UE stays in the wakeup mode after the UE transmits the SR to the base station at the time point 306A until the UE finishes transmitting the uplink signals in the transmission period 304B. Similarly, the UE stays in the wakeup mode starting from time points 306B and 306C to transmit SR to the base station and prepare for uplink transmissions in the time periods 304C and 304D.

In some aspects, the UE can measure signal qualities of neighboring cells when in the wakeup mode. For example, when the UE wakes up at the time point 306A, the UE can start measuring signal qualities of the neighboring cells. In such a case, when the UE needs to perform handover, the UE can handover to, or at least prioritize, neighboring cells with good relative signal qualities. Similarly, the UE can also start measuring the neighboring cells at the time points 306B and 306C.

FIG. 3B illustrates an example 300B of a wakeup-sleep cycle with an adjusted scheduling request (SR), according to aspects of the disclosure. The example 300B is provided for the purpose of illustration only and does not limit the disclosed aspects. As a convenience and not a limitation, FIG. 3B may be described with regard to elements of FIGS. 1, 2, and 6. The example 300B may represent the operation of electronic devices (for example, the UE 102 and the base stations 104 and 106 of FIG. 1) implementing the sleep mode measurements. The example 300B may also be performed by the electronic device 200 of FIG. 2, controlled or implemented by processor 210, and/or computer system 600 of FIG. 6.

In some aspects, the example 300B includes time points 308A, 308B, 308C, 308D, 308E, 308F, and 308G. A base station, such as the base station 104, serving a UE, such as the UE 102, can transmit downlink data at these time points. The UE can wake up to receive the downlink data or stay in the sleep mode at these time points. For example, if the downlink data include wakeup signals, the UE can wake up to receive signals. However, if the downlink data does not include wakeup signals, the UE can stay in the sleep mode.

In some aspects, the UE can be configured with uplink data transmission time periods, such as transmission periods 310A, 310B, 310C, and 310D. The UE wakes up and transmits uplink data in these transmission periods. The uplink data include speech frames as discussed above and other data to be sent to the base station. Thus, regardless of whether the UE wakes up in the time points 308A, 308B, 308C, 308D, 308E, 308F, and 308G to receive downlink signals, the UE can wake up in the transmission periods 310A, 310B, 310C, and 310D to transmit uplink signals.

In some aspects, the UE requests resources from the base station before transmitting the uplink data, similar as FIG. 3A. However, unlike FIG. 3A where the UE transmits the SR at the time points 306A, 306B, and 306C, the UE transmits SR in time points 312A, 312B, and 312C in FIG. 3B. As shown in FIGS. 3A and 3B, the time points 312A, 312B, and 312C are later in time when compared with the time points 306A, 306B, and 306C. Thus, the UE transmits the SR closer to the transmission periods 310A, 310B, 310C, and 310D when compared to SR transmissions of FIG. 3A. In such a case, the UE can stay in the sleep mode longer to reduce energy consumption.

In some aspects, because the UE stays in the sleep mode prior to the time point 312A, the UE may refrain from measuring neighboring cells. However, the UE may need to handover to a new cell when the UE wakes up at the time point 312A. For example, the UE can be moving in a vehicle and is too far from the base station currently serving the UE when the UE wakes up at the time point 312A. In such a case, the UE needs to perform the handover before transmitting in the transmission period 310B. Because the UE transmits the SR at the time point 312A, which is closer to the transmission period 310B (when compared to 306A of FIG. 3A), the UE may not be able to finish the handover before the transmission period 310B starts. Consequently, the UE's uplink transmission may be impacted.

In some aspects, the UE can measure the neighboring cells even in the sleep mode, e.g., perform sleep mode measurements. In such a case, the handover procedure requires less time to complete because the UE can handover to, or at least prioritize, cells that have better signal qualities. Thus, the UE can finish the handover prior to the start of the transmission period 310B and the uplink transmission is not impacted. The tradeoff of measuring the neighboring cells in the sleep mode is additional energy consumption. In some aspects, the UE can limit the sleep mode measurements under certain predetermined conditions. For example, the UE can perform the sleep mode measurements when the UE is conducting jitter-prone communication, such as a voice communication, streaming, gaming, and other delay-sensitive communications. For another example, the UE can perform the sleep mode measurements when the UE is moving and thus is more likely to require a handover.

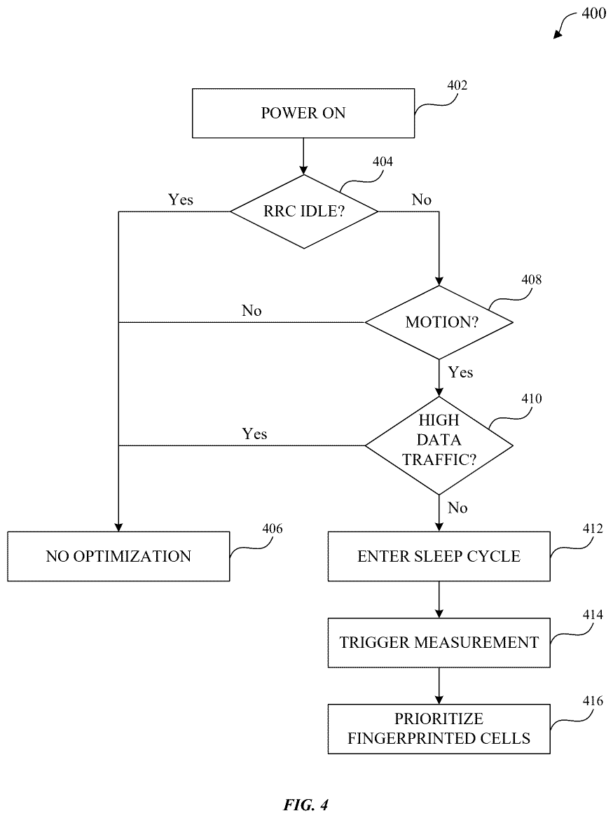

FIG. 4 illustrates an example method 400 of sleep mode measurements, according to aspects of the disclosure. The example method 400 is provided for the purpose of illustration only and does not limit the disclosed aspects. As a convenience and not a limitation, FIG. 4 may be described with regard to elements of FIGS. 1, 2, and 6. The example method 400 may represent the operation of electronic devices (for example, the UE 102 and the base stations 104 and 106 of FIG. 1) implementing the sleep mode measurements based on motion estimation. The example method 400 may also be performed by the electronic device 200 of FIG. 2, controlled or implemented by processor 210, and/or computer system 600 of FIG. 6. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, a UE, such as the UE 102, is powered on. In some aspects, the UE can conduct a cell search and connect to a serving cell for communication after powering on.

At 404, the UE determines whether the UE is in a radio resource control (RRC) idle state. In some aspects, the UE can be registered with the network, but not actively communicating with the serving cell. For example, the UE can maintain information regarding the serving cell and connect to the serving cell when the UE exits the RRC idle state. However, the UE does not actively transmit or receive data via the serving cell. In such a case, the UE determines that the UE is in RRC idle state and the control moves to 406. At 406, the UE refrains from performing any optimization steps, such as sleep mode measurements.

Referring back to 404, the UE may determine that the UE is not in the RRC idle state. For example, the UE can determine that the UE is in an RRC connected state or an RRC inactive state, both of which are not the RRC idle state. In the RRC connected state, the UE actively transmits data to and receives data from the serving cell. In the RRC inactive state, the UE maintains a partial connection with the serving cell while saving power and reducing signaling overhead compared to the RRC connected state. In either the RRC connected state or RRC inactive state, the UE determines that the UE is not in the RRC idle state and the control moves to 408. If the UE is in the RRC idle state, then control moves to 406.

At 408, the UE determines whether the UE is in a motion state. In some aspects, the UE includes a motion sensor (e.g., motion sensor 270) that can detect movements of the UE. For example, the motion sensor can measure a velocity of the UE, which includes a speed and a direction. In some aspects, the UE can determine that the UE is in a stationary state when the speed is zero, meaning that the UE is not moving at all. The UE can also determine that the UE is in the stationary state when the speed is smaller than a speed threshold. Thus, the UE in the stationary state is either moving at a low speed below a threshold or not moving at all. In either case, the UE determines that the UE is not in the motion state, i.e., in the stationary state, and the control moves to 406, where no optimization step is taken.

Referring back to 408, if the UE determine that the speed of the UE is higher than the speed threshold, and thus is in the motion state, then control moves to 410.

At 410, the UE determines whether the UE is conducting a high data traffic communication. In some aspects, the high data traffic communication can be in a standalone (SA) mode, non-standalone (NSA) mode, or a new radio dual connectivity (NRDC) mode. The high data traffic communication can carry a large amount of data, but is not time sensitive. For example, the high data traffic communication can facilitate retransmissions, complex coding, high-order modulation, and/or other mechanisms to achieve high data throughput and reliable transmission. If the UE is conducting a high data traffic communication, then the control moves to 406, where no optimization step is taken.

Referring back to 410, if UE determines that the UE is not conducting a high data traffic communication, then control moves to 412. In some aspects, the UE may determine that the UE is conducting a jitter-prone communication, such as a voice communication, streaming, gaming, and other delay-sensitive communications, all which are not high data traffic. For example, the UE may conduct a voice over new radio (VoNR) call or a voice over long term evolution (VoLTE) call in the SA mode, NSA mode, or the NRDC mode.

At 412, the UE enters a sleep cycle. In some aspects, the UE toggles between a sleep mode and a wakeup mode in the sleep cycle. Thus, the UE switches to the sleep mode when it enters the sleep cycle and switches back to the wakeup mode when enters a wakeup cycle. In the sleep mode, the UE refrains from, or at least limits, transmitting and receiving signals. For example, the UE can power off the transceiver of the UE to reduce energy consumption.

At 414, the UE triggers signal measurements of neighboring cells. In some aspects, the UE triggers the measurement while in the sleep mode and thus can be also referred to as sleep mode measurements. In some aspects, the UE performs sleep mode measurements by measuring signal qualities of the neighboring cells. For example, the UE can measure signal strengths of signals received from the neighboring cells. Furthermore, the UE can rank the neighboring cells based on their respective signal strengths. Similarly, the UE can also measure SNR or SINR of the signals received and rank the neighboring cells based on the measured SNR or SINR. In some aspects, the UE generates a list of neighboring cells based on the sleep mode measurement. The list is ranked from high to low based on the signal strengths, SNR, and/or SINR.

In some aspects, the UE triggers the sleep mode measurements based on entry conditions. For example, the entry conditions include that the UE is in the motion state. In some aspects, the motion state requires the UE to move faster than a predetermined speed threshold. For another example, the entry conditions include that the UE is performing a jitter-prone communication, such as a voice communication. In some aspects, the entry conditions also require that the UE perform the jitter-prone communication for a first predetermined period of time. For yet another example, the entry conditions include that the UE is in the RRC connected state or the RRC inactive state.

In some aspects, the UE stops the sleep mode measurements based on exit conditions. For example, the exit conditions include that the UE is in the stationary state. In some aspects, the UE may be in the motion state and can trigger the sleep mode measurements. After the UE starts measuring the neighboring cells, the UE stops moving and thus is in the stationary state. In such a case, the UE stops the sleep mode measurements. For another example, the exit conditions include that the UE stops the jitter-prone communication, such as a voice communication. For yet another example, the exit conditions include that the UE switches from the RRC connected state or the RRC inactive state to the RRC idle state. For yet another example, the exit conditions include that the UE completed a handover procedure within a second predetermined period.

In some aspects, the logic of the exit conditions is that there is no need for the sleep mode measurements. For example, when the UE is in the stationary state, it is less likely that the signal qualities would change and thus handover is unlikely and the sleep mode measurement is unnecessary. Similarly, when the UE has recently performed the handover procedure, the UE is likely to stay with a new cell that the UE handover to and another handover is less likely. In some aspects, the logic of the exit conditions is that a handover is possible but is less likely to impact the UE performance. For example, when the UE is in the RRC idle state, the UE is not actively performing communication anyway and thus a handover does not impact the UE performance. For another example, when the UE is conducting the high data traffic communication, such communication is not sensitive to delays and thus can wait and resume after the handover is complete.

At 416, the UE wakes up and performs a handover using prioritized fingerprinted cells. In some aspects, when the UE switches from the sleep mode to an active mode (or a wakeup mode), such as at the time point 312A, the UE may determine that a signal strength from a serving cell is below a handover threshold. For example, the serving cell may be supported by a serving base station, such as the base station 104, and the UE is moving away from the serving base station. In such a case, the UE determines that the handover is needed. In some aspects, the UE starts the handover process with a cell search that locates candidate cells to handover to. Here, the cell search can be boosted with a shortlist of candidate cells based on results of the sleep mode measurements. For example, the UE generates the list of neighboring cells based on the sleep mode measurements as discussed above. The UE can also fingerprint one or more neighboring cells on the list. The fingerprinted one or more neighboring cells may rank top percentage, such as 10%, on the list. The fingerprinted one or more neighboring cells may also have signal strengths higher than a fingerprinting threshold. In either case, the UE starts the cell search based on the fingerprinted one or more neighboring cells. In this way, the UE can locate a suitable cell quickly and complete the handover in a short amount of time to reduce the impact on communication that the UE is conducting, such as a voice communication in VoNR or VoLTE.

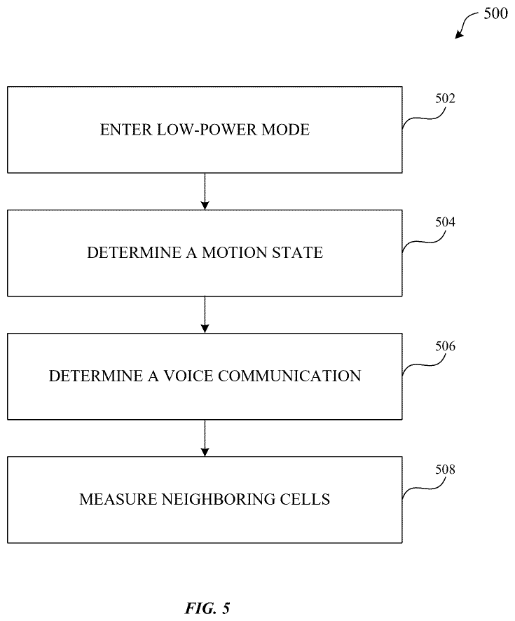

FIG. 5 illustrates an example method 500 of the sleep mode measurements in a motion state and during a voice communication, according to aspects of the disclosure.

The example method 500 is provided for the purpose of illustration only and does not limit the disclosed aspects. As a convenience and not a limitation, FIG. 5 may be described with regard to elements of FIGS. 1, 2, and 6. The example method 500 may represent the operation of electronic devices (for example, the UE 102 and the base stations 104 and 106 of FIG. 1) implementing the sleep mode measurements. The example method 500 may also be performed by the electronic device 200 of FIG. 2, controlled or implemented by processor 210, and/or computer system 600 of FIG. 6.

At 502, a UE, such as the UE 102, enters a low-power mode. In some aspects, the low-power mode is also referred to as a sleep mode. The UE can turn off or limit transceiver e.g., transceiver 220) of the UE in the low-power mode. For example, the UE refrains from actively transmitting or receiving using the transceiver. In some aspects, the transceiver may include a main transceiver and a secondary transceiver. In such a case, the UE can turn off the main transceiver and keep the secondary transceiver on.

Accordingly, the low-power mode utilizes less power than an active mode (e.g., RRC connected mode), where the UE is performing active data transmission or reception).

At 504, the UE can determine that the UE is in a motion state. In some aspects, the UE includes a motion sensor that can determine a speed of the UE. When the speed is higher than a threshold, the UE determines that the UE is in the motion state. Otherwise, the UE determines that the UE is in a stationary state.

At 506, the UE can determine that the UE is conducting a voice communication. In some aspects, the voice communication can be a VoNR communication or a VoLTE communication. The voice communication can also include speech and silent frames. For example, the UE can transmit speech frames when the UE is a wakeup mode or an active mode. In the sleep mode or the low-power mode, the UE can transmit the silent frames using the secondary transceiver. The silent frames can include an indication that no voice is detected and thus is very small. In such a case, transmitting the silent frames consumes limited energy and can be handled by the secondary transceiver. Alternatively, the UE can refrain from transmitting when detecting the silent frame. A base station can assume that no voice was detected when nothing is received. In either case, the UE can determine that the UE is conducting a voice communication and will resume transmitting and receiving once the UE switches to the wakeup mode. In some embodiments, the UE can determine that the UE has performed the voice communication for a first predetermined period.

At 508, the UE measures respective signal qualities of neighboring cells in the low-power mode. In some aspects, the UE measures the neighboring cells when the UE is in the motion state and that the UE is performing the voice communication. The UE can also generate a list of neighboring cells that have been measured. The list can be ranked by signal qualities of the neighboring cells, such as signal strengths, SNR, or SINR. In such a case, when UE wakes up and determines that a handover is needed, the UE can use the list to conduct a cell search. For example, the UE can prioritize searching top neighboring cells on the list. Because the top neighboring cells are known to have better signal qualities than other neighboring cells on the list, it is likely that the UE can find a suitable cell to handover to out of the top neighboring cells. In such a case, the time required for the cell search can be reduced and thus the time required for the handover procedure can also be reduced.

Various aspects may be implemented, for example, using one or more computer systems, such as computer system 600 shown in FIG. 6. One or more computer systems 600 may be used, for example, to implement any of the aspects discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 6. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a transceiver; and
a processor communicatively coupled to the transceiver and configured to:
configure the UE to enter a low-power mode;
determine that the UE is in a motion state;
determine that the UE has performed a voice communication for a first predetermined period; and
in response to determining that the UE is in the motion state and that the UE has performed the voice communication for the first predetermined period, measure signal qualities of neighboring cells while the UE is in the low-power mode.

2. The UE of claim 1, wherein the voice communication includes a voice over new radio (VoNR) communication or a voice over long term evolution (VoLTE) communication.

3. The UE of claim 1,
wherein the processor is further configured to generate a list of cells based on a result of measuring signal qualities of the neighboring cells, and
wherein cells in the list are ranked by signal strengths.

4. The UE of claim 3, wherein the processor is further configured to:
switch from the low-power mode to an active mode; and
initiate a hand-over procedure to a cell in the list of cells.

5. The UE of claim 1, wherein the processor is further configured to:
determine that the UE has transitioned to a stationary state; and
refrain from measuring the signal qualities of the neighboring cells based on the determination that the UE has transitioned to the stationary state.

6. The UE of claim 1, wherein the processor is further configured to:
determine that the voice communication has ended; and
refrain from measuring the signal qualities of the neighboring cells based on the determination that the voice communication has ended.

7. The UE of claim 1, wherein the processor is further configured to:
determine that the UE completed a hand-over procedure within a second predetermined period; and
refrain from measuring the signal qualities of the neighboring cells based on the determination that the UE has completed the handover procedure within the second predetermined period.

8. The UE of claim 1, wherein the processor is further configured to:
determine that the UE switches from a connected state to an idle state; and
refrain from measuring the signal qualities of the neighboring cells based on the determination that the UE has switched from the connected state to the idle state.

9. A method of operating a user equipment (UE) comprising:
configuring the UE to enter a low-power mode;
determining that the UE is in a motion state;
determining that the UE has performed a voice communication for a first predetermined period; and
in response to determining that the UE is in the motion state and that the UE has performed the voice communication for the first predetermined period, measuring signal qualities of neighboring cells while the UE is in the low-power mode.

10. The method of claim 9, further comprising
generating a list of cells based on a result of measuring signal qualities of the neighboring cells,
wherein cells in the list are ranked by signal strengths.

11. The method of claim 10, further comprising:
switching from the low-power mode to an active mode; and
initiating a hand-over procedure to a cell in the list of cells.

12. The method of claim 9, further comprising:
determining that the UE has transitioned to a stationary state; and
refraining from measuring signal qualities of the neighboring cells based on the determination that the UE has transitioned to the stationary state.

13. The method of claim 9, further comprising:
determining that the voice communication has ended; and
refraining from measuring signal qualities of the neighboring cells based on the determination that the UE has completed the handover procedure within the second predetermined period.

14. The method of claim 9, further comprising:
determining that the UE completed a hand-over procedure within a second predetermined period; and
refraining from measuring the signal qualities of the neighboring cells based on the determination that the UE has completed the handover procedure within the second predetermined period.

15. The method of claim 9, further comprising:
determining that the UE switches from a connected state to an idle state; and
refraining from measuring the signal qualities of the neighboring cells based on the determination that the UE has switched from the connected state to the idle state.

16. A non-transitory computer-readable medium (CRM) comprising instructions, wherein upon execution of the instructions by one or more processors of a user equipment (UE), causes the UE to perform operations, the operations comprising:
configuring the UE to enter a low-power mode;
determining that the UE is in a motion state;
determining that the UE has performed a voice communication for a first predetermined period; and
in response to determining that the UE is in the motion state and that the UE has performed the voice communication for the first predetermined period, measuring signal qualities of neighboring cells while the UE is in the low-power mode.

17. The non-transitory CRM of claim 16, wherein the operations further comprise:
generating a list of cells based on a result of measuring the neighboring cells,
wherein cells in the list are ranked by signal strengths.

18. The non-transitory CRM of claim 17, wherein the operations further comprise:
switching from the low-power mode to an active mode; and
initiating a hand-over procedure to a cell in the list of cells.

19. The non-transitory CRM of claim 16, wherein the operations further comprise:
determining that the UE has transitioned to a stationary state; and
refraining from measuring the signal qualities of the neighboring cells based on the determination that the UE has transitioned to the stationary state.

20. The non-transitory CRM of claim 16, wherein the operations further comprise:
determining that the UE completed a hand-over procedure within a second predetermined period; and
refraining from measuring the signal qualities of the neighboring cells based on the determination that the UE has completed the handover procedure within the second predetermined period.
